(19) United States
(12) Patent Application Publication
(10) Pub. No.: US 2017/0124376 A1
(43) Pub. Date: May 4, 2017

(54) INFRARED FLUORESCENT BACKLIGHT FOR OPTICAL TOUCH AND FINGERPRINT

(71) Applicant: QUALCOMM Incorporated, San Diego, CA (US)

(72) Inventors: John Wyrwas, Mountain View, CA (US); Evgeni Petrovich Gousev, Saratoga, CA (US); Khurshid Alam, Mountain View, CA (US); Hae-Jong Seo, San Jose, CA (US)

(21) Appl. No.: 15/266,150

(22) Filed: Sep. 15, 2016

Related U.S. Application Data
(60) Provisional application No. 62/247,542, filed on Oct. 28, 2015.

(51) Int. Cl. G06K 9/00; G09G 3/36; G09G 3/34; G06F 3/041

(52) U.S. Cl. CPC G06K 9/00013; G06F 3/0412; G09G 3/36; G09G 3/3406; G09G 2320/0626

(57) ABSTRACT

Methods, systems, computer-readable media, and apparatuses for biometric imaging are presented. The biometric imaging can include emitting light, using a light emitter, wherein the emitted light passes through a display comprising quantum dots. The quantum dots can be configured to emit non-visible light. The biometric imaging can further include sensing, using a sensor, the non-visible light emitted from the quantum dots and reflected from an object to be imaged.

### CROSS-REFERENCE TO RELATED APPLICATIONS

This application claims priority to U.S. Provisional Application No. 62/247,542, filed Oct. 28, 2015, the disclosure of which is incorporated by reference herein in its entirety.

### BACKGROUND

Aspects of the disclosure relate to biometric imaging systems for mobile devices.

Today, mobile devices can be multi-functional devices (e.g., smartphones) that can be used for a wide variety of purposes including social interaction, financial transactions, personal healthcare management, work-related communications, business dealings, etc. As such, these devices can store and/or display confidential and/or sensitive data. Biometric (e.g., fingerprint) recognition on mobile devices can provide an enhanced level of device security for a user (e.g., owner) of the mobile device, as it can be difficult to duplicate or imitate the user's biometric data. Additionally, biometric sensors can offer a level of convenience by enabling quick, secure access to a mobile device.

As mobile devices become more complex, space allocated to each component of a mobile device becomes increasingly constrained. In response, biometric sensors for mobile devices, including fingerprint sensors, are becoming increasingly integrated and miniaturized. Space constraints within mobile electronic devices can make integrating, positioning, and configuring biometric sensors difficult, especially while maintaining sufficient system performance necessary to consistently and accurately perform biometric scans for authenticating a user of a mobile device.

Accordingly, a need exists for improved biometric imaging systems for mobile devices.

### BRIEF SUMMARY

Certain embodiments are described pertaining to biometric imaging. For example, a biometric imaging system may include a light emitter, a sensor, a cover glass, and a quantum dot element disposed between the light emitter and the cover glass. The quantum dot element can be configured to emit non-visible light in response to light emitted by the light emitter being incident upon the quantum dot element. The quantum dot element can be configured to emit the non-visible light through the cover glass at an angle less than a critical angle of the cover glass to preclude the non-visible light from totally internally reflecting within the cover glass prior to reflecting from a biometric object. The sensor can be configured to detect non-visible light reflected from the object.

The sensor can be further configured to detect the non-visible light reflected from the object when the object contacts the surface of the cover glass. The non-visible light can totally internally reflect within the cover glass after reflecting from the object before being detected by the sensor. The system can further include a Liquid Crystal Display (LCD) pixel disposed between the quantum dot element and the cover glass, wherein the non-visible light passes through the LCD. The quantum dot element can be further configured to emit visible light in response to the light emitted by the light emitter incident upon the quantum dot element. The quantum dot element can be further configured to emit the visible light at two or more different wavelengths, the two or more different wavelengths corresponding to visible colors.

The quantum dot element can be further configured to emit each of the two or more different wavelengths through a respective cell of an LCD. The two or more different wavelengths include wavelengths corresponding to red, blue, and green colors of light. The quantum dot element can be further configured to emit the non-visible light through a cell of the LCD. The sensor can includes an imaging sensor configured to capture an image of the object using the non-visible light. The non-visible light can include infrared light.

In certain embodiments, a method is disclosed including emitting light, at a light emitter. The method can further include emitting non-visible light, at a quantum dot element, in response to the light emitted by the light emitter being incident upon the quantum dot element. The non-visible light can be emitted through the cover glass at an angle less than a critical angle of the cover glass to preclude the non-visible light from totally internally reflecting within the cover glass prior to reflecting from a biometric object. The method can also include detecting, at a sensor, non-visible light reflected from the object.

The non-visible light can be totally internally reflected within the cover glass after reflecting from the object and before being detected by the sensor. The method can further include emitting visible light, at the quantum dot element, in response to the light emitted by the light emitter being incident upon the quantum dot element. The method can also include emitting, at the quantum dot element, two or more different wavelengths of light corresponding to visible colors. The method can additionally include emitting the two or more different wavelengths, at the quantum dot element, through a respective cell of a LCD. The two or more different wavelengths can correspond to visible colors including red, blue, and green colors of light. The method can also include emitting each of the two or more different wavelengths through a respective cell of the LCD. The method can additionally include capturing an image of the object using the non-visible light at the sensor.

In certain embodiments, an imaging system is disclosed including a means to emit light, a means to sense light, and a means to emit non-visible light in response to light emitted by the means to emit light being incident upon the means to emit non-visible light. The means to emit non-visible light can be configured to emit the non-visible light through the cover glass at an angle less than a critical angle of the cover glass to preclude the non-visible light from totally internally reflecting within the cover glass prior to reflecting from a biometric object. The means to sense light can be configured to detect non-visible light reflected from the object.

### BRIEF DESCRIPTION OF THE DRAWINGS

Aspects of the disclosure are illustrated by way of example. In the accompanying figures, like reference numbers indicate similar elements.

FIG. 1 illustrates a simplified diagram of a biometric scanning device that may incorporate features of one or more embodiments;

FIGS. 2A and 2B illustrate a simplified diagram of a biometric scanning device using a quantum dot element that may incorporate features of one or more embodiments;

FIG. 3 illustrates a simplified diagram of a quantum dot element interacting with LCD cells according to certain embodiments;

FIG. 4 illustrates features of emitted light through a cover glass according to certain embodiments;

FIG. 5 illustrates a flowchart for implementing techniques using certain embodiments;

FIG. 6 illustrates a flowchart for implementing a device using certain embodiments; and

FIG. 7 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Display devices for use in mobile device (e.g., smartphones, tables, laptops, etc.) and other devices can utilize Liquid Crystal Display (LCD), Organic Light Emitting Diode (OLED) or other display technologies to display images to a user. These display technologies can utilize a cover glass to form a barrier between display components and an environment external to the display (and a user of the mobile device). As used herein, a cover glass is a component of a display in which a user can make direct contact using an appendage. A cover glass does not need be made of glass and can contain various polymers, glasses, or other materials in any combination. Thus, a cover glass can form a barrier to protect display component(s) from dust, oil, damage due to pressure, or other adverse conditions. A cover glass for a mobile device can also be used as an input interface through the use of various techniques (e.g., capacitance or resistive sensors, etc.). For example, smartphones routinely make use of displays with cover glasses that can be used by a user to interact with a User Interface (UI) displayed through the cover glass.

As mobile devices become more complex, space available for certain individual components (including biometric sensors) has become increasingly constrained as additional features and components are integrated into mobile devices. Additionally, physical constraints of mobile devices, to maintain portability and desires to minimize certain physical dimensions (while maintaining a relatively large display screen), have further limited space allotments for biometric sensors. For these and other reasons, it may be desirable to integrate a biometric sensor (such as a fingerprint scanner) with a display of a device.

Furthermore, a biometric imaging display can provide for more intuitive techniques for biometrically authorizing a user to access a device (or a function of a device), as compared to a dedicated biometric sensor for fingerprint imaging (or a biometric sensor combined with a physical button of a mobile device). For example, techniques disclosed herein can enable continuous authentication and/or validation of a user attempting to access a device or a specific feature of a device (e.g., banking, access to secure remote devices, etc.).

The continuous authentication can include periodically imaging a fingerprint (or a portion of a fingerprint) of a user to generate a inquiry template. The inquiry template can be compared to one or more enrolled templates. If the inquiry template is deemed to sufficiently match an enrolled template, a user can be deemed to be authenticated and/or validated for access to a device or a function of a device. If the inquiry template is not found to sufficiently match an enrolled template, the user can be denied access to the device or a function of the device. Certain enrolled templates can be associated with one or more credentials. Thus, if a user's inquiry template matches an enrolled template with insufficient privileges to access a device or a certain function of a device, a user can be denied access to that device or function. As used herein, the term fingerprint can mean a friction ridge surface of an appendage of a user. The appendage can be a finger, toe, or other. Fingerprint imaging systems can take advantage of patterns of blood vascular or other biometric systems.

Disclosed are techniques for enabling use of a cover glass of a display to function as a visual display surface as well as a fingerprint imaging surface. Thus, a user can present their finger upon a surface of a cover glass of a display, and a device using the display can image the fingerprint to validate and/or authenticate the user. In certain embodiments, non-visible light can be emitted through the cover glass of a display along with visible light. The visible light can form a UI on the display and be viewed by the user. The non-visible light can be used to image a fingerprint of the user without disrupting the user's ability to view the UI (or other information displayed via the visible light). The non-visible light can be infrared light (light with wavelength of 700 nm to 1 mm, for example). The visible light can have wavelength(s) of 400 nm to 700 nm, for example.

In certain embodiments, a quantum dot element can be used to generate visible and/or non-visible light. A quantum dot element, as used herein, is a physical object that includes one or more quantum dots. A quantum dot is a nanoscale particle comprised of semiconducting material. When excited (such as via application of light), a quantum dot can emit light at a wavelength determined by physical properties of the quantum dot. The emission at a certain wavelength can occur regardless of a wavelength of light incident upon a quantum dot. Thus, certain quantum dots can emit non-visible light and certain other quantum dots can emit visible light, regardless of whether light incident upon the quantum dots is visible or non-visible. Additionally, different wavelengths of non-visible or visible light can be emitted by quantum dots. A quantum dot element can be configured to emit various wavelengths of light from different portions of the quantum dot element. Using a quantum dot element in conjunction with a cover glass can enable non-visible and visible light to be emitted through the cover glass.

Disclosed are techniques including use of a quantum dot element to emit non-visible light through a cover glass for imaging of a biometric object (e.g., finger) of a user. The quantum dot element can be used in conjunction with Light Emitting Diode (LED), fluorescent or other backlight technologies with an LCD. The quantum dot element can be used in conjunction with OLED display technologies. Furthermore, the quantum dot element can improve color reproduction by an LCD, OLED, or other display. The quantum dot element can provide fingerprint imaging functionality in a compact and relatively inexpensive package. Thus, techniques for improving biometric imaging systems for mobile devices are disclosed.

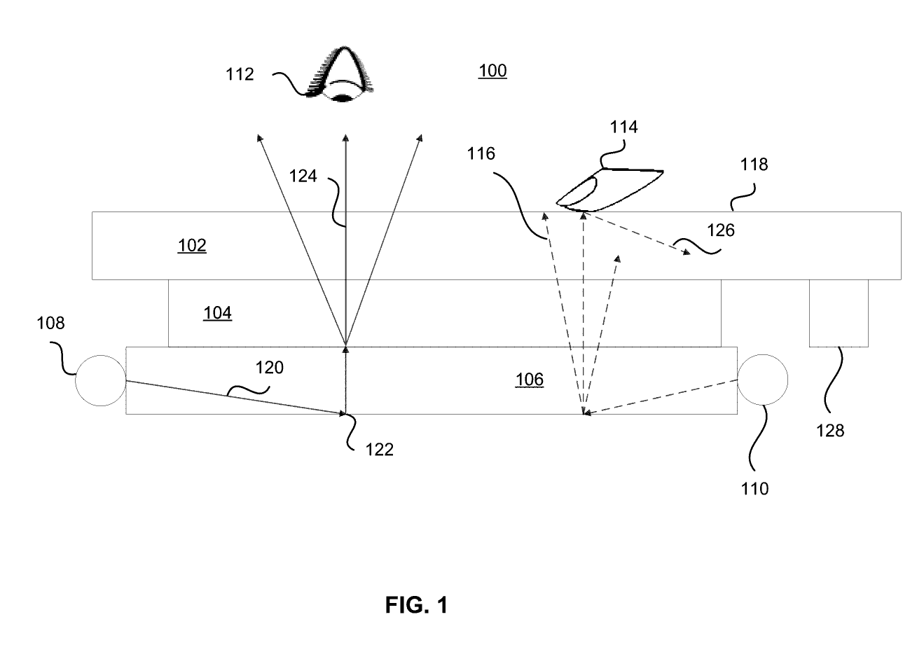

FIG. 1 illustrates a simplified diagram embodying several features of the disclosure. FIG. 1 illustrates a system 100 that can be used as a display for a mobile device as well as a biometric sensor for imaging a biometric object 114. The system 100 can include a cover glass 102, a Liquid Crystal Display (LCD) display component 104, and a backlight 106. The illustrated backlight 106 is arranged as a light guide to guide light emitted from light emitter 108. Light emitter 108 is arranged at an edge of the light guide. Here, backlight 106 is illustrated as an edge-lit backlight. It should be understood that the system disclosed can be used with a variety of backlight technologies. For example, the backlight 106 can be one or more light emitters arranged directly behind LCD component 104. The backlight 106 can be a matrix backlight, a fluorescent backlight, or other. Light emitter 108 and/or backlight 106 can include a light emitting diode, fluorescent lamp, prism, reflective polarizer, or other. Light emitter 108 and/or backlight 108 can be configured to emit light at several different wavelengths, as will be further described herein.

It should be understood that the system disclosed can be used with a variety of display technologies including the disclosed LCD display. For example, LCD component 104 can include an array of cells that can be polarized to allow light to be transmitted there through. In particular, each cell can be arranged to attenuate light in a first state and to substantially transmit light in a second state. Each cell can be associated with a color (wavelength) of visible or non-visible light. By combining cells for attenuating primary colors (e.g., red, green, and blue), for example, a pixel of a display can be formed. By adjusting the attenuation of each cell of a pixel, the pixel can be configured to emit any color combination of the primary cell colors.

The light emitter 108 can be used to emit light 120 that can be reflected or otherwise dispersed at point 122 of backlight 106 and guided as illustrated. Redirected light 124 can make contact with an eye 112 of a user so that the user can see the images. System 100 can be integrated into a smartphone or other device to form a display for displaying various information to a user (e.g., emails, phone numbers, movies, games, etc.). Light emitter 108 can include several light emitters each configured to emit light at a substantially different wavelength (i.e., color) of light. Each color of light emitted can correspond to a different backlight 106 light guide or a different path/portion of a light guide of backlight 106, to guide each color to a corresponding cell of LCD component 104. For example, red light can be emitted and guided to LCD cells for displaying red light. Likewise, a respective emitter and backlight 106 can be configured for guiding green and blue light. Thus, system 100 is a simplified diagram of a display system.

A non-visible light emitter 110 can be used to emit non-visible light for biometric imaging. Non-visible light 116 emitted from the non-visible light emitter 110 can enter the cover glass 102 after reflecting or otherwise being diverted by backlight 106. Note that a different light guide distinct from backlight 106 used for visible light can be used to guide non-visible light 116 to cover glass 102 or the same backlight 106 can be used. Non-visible light 116 can be used to image a biometric object placed against the cover glass 102. For example, biometric object 114 can be a finger of a user placed against a surface 118 of the cover glass 102. Reflected non-visible light 126 that has reflected after contact with the biometric object 114 can be received by a sensor 128. Sensor 128 can be an imaging sensor (e.g., a charge-coupled device (CCD) or a complementary metal-oxide semiconductor (CMOS)). In this manner, the cover glass 102 can be used for displaying images as well as for biometric imaging. The non-visible light 116 emitted from the non-visible light emitter 110 can be infrared, for example, so that it is not visible by a user. In this manner, the imaging of the biometric object 114 can occur without interfering with the ability of the system 100 to operate as a visible display.

Although not illustrated, sensor 128 and/or light emitter 108 or 110 can be coupled to a processor and/or memory. The processor can be configured to perform fingerprint template generation and matching or other biometric authentication techniques. The memory, for example, can store biometric enrollment templates to be matched to later acquired matching template(s) acquired from a user attempting to be authorized.

The cover glass 102 can be curved or take a variety of shapes. Additionally, it should be understood that the cover glass 102 can be comprised of glass or a variety of other materials and can include various coatings to improve the durability of the cover glass 102 or to alter optical properties of the cover glass 102. Although not illustrated, LCD component 104 can include OLED display features which can negate the need to use backlight 106. For example, each light emitting diode of an OLED display can be configured to emit light at a certain wavelength (e.g., blue, green, red, infrared). Thus, a plurality of diodes can form a pixel of a display for an OLED display. Infrared emitting diodes can be arranged across an OLED display to enable imaging of a biometric object, as disclosed herein.

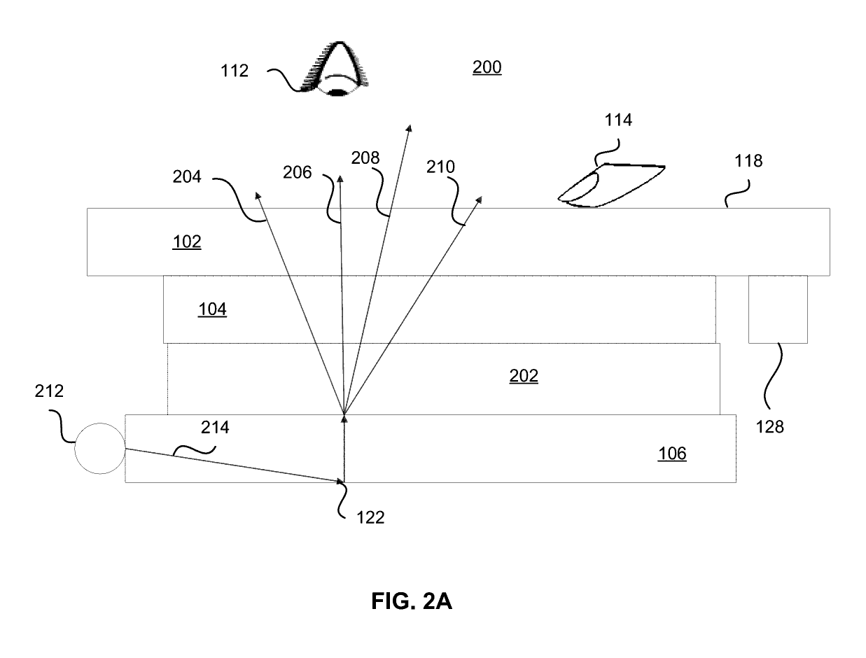

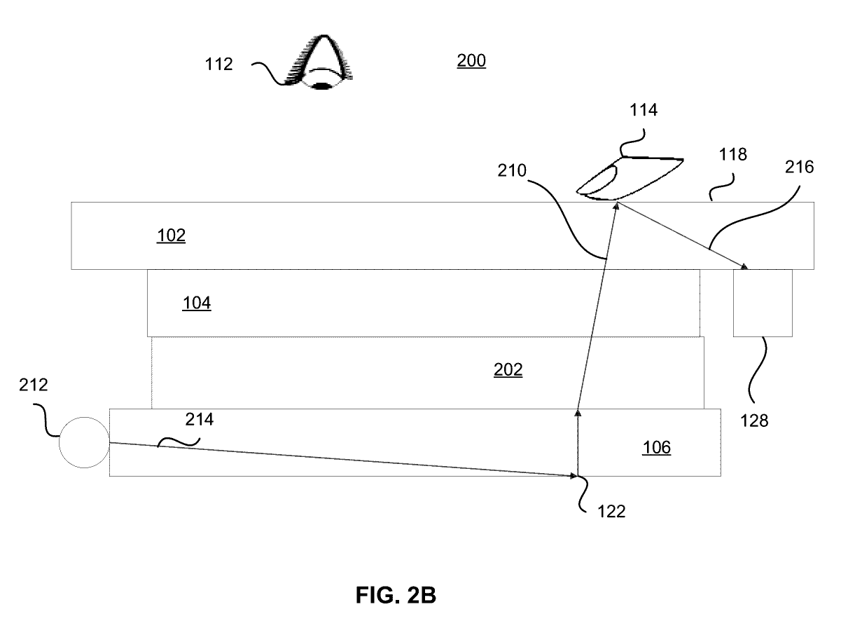

FIGS. 2A and 2B illustrate simplified diagrams embodying several features of the disclosure including use of a quantum dot element 202. The system 200 of FIG. 2 can be operable to display image(s) to a user as well as to operate as a biometric scanner using a cover glass 102, similar to the system 100 of FIG. 1. However, the system 200 of FIG. 2 is able to perform these functions without the need to use two or more separate light emitters. Instead, a single light emitter 212 is used to emit light for both functions.

The system 200 can make use of quantum dots to generate non-visible light (such as infrared light) for biometric imaging. Quantum dots are crystalline structures made of semiconductor materials and can be small enough to exhibit quantum mechanical properties wherein the quantum dot's excitons are confined in all three spatial dimensions. By confining the excitons, photons can be emitted by quantum dots at a predetermined wavelength depending on the dimensions of the crystalline structures. Therefore, a quantum dot can be excited by a photon of any wavelength (e.g., any wavelength within an operational range) and then emit a corresponding photon at a set wavelength. In this manner, a quantum dot can operate as a high efficiency converter to emit a certain wavelength of light. In other words, an element comprising quantum dots can operate somewhat analogous to a filter, but at much higher efficiency because, whereas a filter can absorb/block light of unwanted wavelength, quantum dots can convert light to different wavelengths without such absorption/blockage. Quantum dots can be made from materials such as lead sulfide, lead selenide, cadmium selenide, cadmium sulfide, indium arsenide, or indium phosphide, as well as other materials.

The system 200 can take advantage of properties of quantum dots to display visible and non-visible light. The system 200 includes a quantum dot element 202 that can include quantum dots. The quantum dots can each be configured to emit light at set wavelengths. Some quantum dots can be configured to emit light at a first wavelength and some quantum dots can emit light at a second wavelength. For example, quantum dot element 202 can include quantum dots configured to emit light with wavelengths corresponding to visible primary colors or red, green, and blue as well as infrared light. The red, green, and blue emitting quantum dots can be arranged corresponding to LCD cells of the LCD component 104. Each cell can be used to make a subpixel of a displayed pixel. Each pixel can comprise subpixels of respective red, green, and blue colors to display a wide range of colors for each pixel of a displayed image. In certain embodiments, primary color emitting quantum dots can be used in conjunction with a filter corresponding to each subpixel. For example, quantum dots can be used to emit primary colors of light having relatively narrow frequency ranges centered around a primary color. Filtering can be utilized in certain embodiments to filter a respective one of primary color(s) emitted by quantum dots. Similarly, quantum dots can be arranged in multiple stages wherein primary color(s) are emitted by a first quantum dot element and then a subset of the primary color(s) are emitted by a second quantum dot element. In certain embodiments, quantum dots can be arranged in any manner of stages/arrangement to emit visible light or non-visible light at one or more wavelengths. Quantum dots can be arranged to emit infrared light in a uniform manner across cover glass 102, or in certain areas or patterns on cover glass 102. For example, a portion of the cover glass 102 can be designated to operate as a biometric scanner in order to, for example, optimize the imaging capabilities of the sensor 128.

Infrared emitting quantum dots can be uniformly arranged to emit infrared light across the entire displayed image. Quantum dot element 202 can be arranged in various positions within system 200. FIG. 2 includes quantum dot element 202 as a separate element, but quantum dot element 20 can be integrated into backlight 106, LCD component 104, or the cover glass 102, for example. Quantum dot element 202 dots can a film that can be applied to any of the aforementioned components. If the quantum dot element 202 is arranged behind LCD component 104, infrared light emitted by the quantum dot element 202 can pass through (i.e., be un-attenuated by) LCD cells of LCD component 104. For example, infrared light (or other wavelengths of non-visible light) can be un-attenuated by an LCD cell configured to attenuate a wavelength of visible light. Thus, infrared light can pass through red, green, or blue attenuating LCD cells regardless of the state of the cells. In this manner, a visible LCD display can also emit infrared light regardless of the state of LCD cells of the LCD display.

In FIG. 2A, a light emitter 212 is illustrated as emitting light 214. The light 214 can make contact with a backlight 106 at point 122 and be guided to quantum dot element 202. Quantum dot element 202 can have variously configured quantum dots to emit one or more wavelengths of light, as disclosed herein. For example, some quantum dots can emit light 204 at one wavelength (color). Additional quantum dots can emit light 206 at a second wavelength. Still additional quantum dots can emit light 208 at a third wavelength. Finally, other quantum dots can emit light 210 at a fourth wavelength. The wavelengths of light 204, 206, and 208 can fall within the visible spectrum for a human being and can correspond to, for example, red, green, and blue light. The wavelength of light 210 can fall outside of the visible spectrum of a human being to be used for biometric imaging using infrared light, for example.

The light emitter 212 can be configured to emit light 214 of various wavelength(s). The light 214 can be of the shortest wavelength of light used by the system 200. For example, if the system 200 displays blue, green, red, and infrared light, the light 214 can be blue light as it has the shortest wavelength of the four types of light. Light with shorter wavelengths can be more readily converted by quantum dots to light with longer wavelengths, since most common state transitions include a single-photon that loses some energy on re-emission. Light with longer wavelengths can comprise lower energy photons. However, given the nature of quantum dots (being able to emit light at a certain wavelength regardless of a wavelength of incident light), light 214 can have various wavelength(s), even some that are not displayed by the system 200. In certain embodiments, quantum dot element 202 can comprise quantum dots configured to transmit only non-visible light for biometric imaging. Such a configuration can be advantageous, for example, when retrofitting a biometric sensor to an already existing display system.

Multiple different wavelengths of non-visible or infrared light may be used in order to increase sensing capability (e.g. use different wavelengths to probe pulse-oximetry from finger, to probe different depths inside the skin, or estimate skin color spectrum). Quantum dots for emitting different wavelengths of non-visible light can be arranged in a pattern with different wavelengths in different locations. Such an arrangement can help extract position information for features of a biometric object, for example. Non-visible light for biometric imaging can be infrared light with wavelength of 700-1000 nm, e.g. 850 nm, 880 nm, and/or 940 nm.

FIG. 2B illustrates an additional path of light 210 used to image biometric object 114. As illustrated, light 214 can be guided from light emitter 212 to quantum dot element 202. Non-visible light 210 can be re-emitted by quantum dot element 202 and pass through LCD component 104 and through cover glass 102. The non-visible light 210 can be reflected or otherwise dispersed by biometric object 114 when biometric object 114 makes contact with cover glass 102 or is otherwise presented in front of cover glass 102 (e.g., in the path of non-visible light 210). Reflected non-visible light 216 from biometric object 114 can be received at sensor 128 for imaging of biometric object 114. For example, biometric object 114 can be placed against a surface 118 of cover glass 102, and non-visible light can reflect from biometric object 114 accordingly.

According to various embodiments, system 200 is configured to control the incident angle at which non-visible light 210 encounters cover glass 102, in order to avoid unwanted total internal reflection when biometric object 114 is not in contact with cover glass 102. When biometric object 114 is in contact with cover glass 102 (i.e., with surface 118), reflected non-visible light 216 may reflect within cover glass 102 and be received at sensor 128, as illustrated. Non-visible light 216 can be reflected by being scattered by biometric object 114, for example. After non-visible light 216 is scattered or otherwise reflected by biometric object 114, non-visible light 216 can, in certain embodiments, internally reflect within cover glass 102 to be received at sensor 128. When biometric object 114 is not in contact with cover glass 102, non-invisible light 210 is intended to be transmitted through cover glass 102 without reflection, resulting in no reflected non-visible light 216 being totally internally reflected and received at sensor 128. In this manner, system 200 may distinguish between a contact state vs. a non-contact state. By employing multiple pixels each making such a contact vs. non-contact distinction, system 200 may generate a contrast image, such as a finger print image. However, if unintended reflections are also generated and received when biometric object 114 is not in contact with cover glass 102, the distinction between the contact state and the non-contact state may become blurred, leading to degradation of the image.

In particular, unintended reflections may occur if non-visible light 210 encounters cover glass 102 at an inappropriate incident angle. The incident angle may be measured between non-visible light 210 and a vector normal to the plane defined by surface 118. Light that encounters a transition between two different materials may reflect off of the transition, if the incident angle formed between the light and a vector normal to the plane of the transition is greater than a critical angle. The critical angle varies depending on the respective indices of refraction of the two materials. Here, if biometric object 114 is not making contact with surface 118 of cover glass 102, the two materials would be the cover glass 102 and open air, and the critical angle would be defined accordingly. Thus, if the incident angle formed between non-visible light 210 and surface 118 is greater than the corresponding critical angle, non-visible light 210 would reflect off of the transition and create unintended reflections that may totally internally reflect within cover glass 102 and eventually reach sensor 128. As used herein, the term total internal reflectance refers to light that reflects from being incident at an angle greater than a critical angle at a barrier formed between two different refractive indexes.

According to various embodiments, quantum dot element 202 is configured to emit non-visible light 210 through the cover glass at an incident angle less than the critical angle. Thus, unintended reflections during the non-contact state may be avoided. In this manner, system 200 may improve the quality of biometric images by increasing the contrast between contact and non-contact states and making the detection of ridges, valleys, minutiae, or other features of a fingerprint more apparent.

Although not illustrated, quantum dot element 202 can be used with OLED or other display techniques. For example, quantum dot element 202 can be used in conjunction with an array of OLED diodes that each emits light at one wavelength (blue for example). For example, certain diodes can correspond to a subpixel of a display. Red subpixels can include quantum dots configured to emit red wavelength light in response to blue light emitted from an OLED diode. Similarly, green light can be emitted even though a blue OLED diode is used to emit blue light. Any combination of subpixels or pixels can include quantum dots configured to emit non-visible light (such as infrared light). Such a configuration can enable visible light of various colors to be used in conjunction with non-visible light with an OLED display emitting light at one wavelength. An OLED configuration may have advantages in contrast and/or power consumption over an equivalent LCD configuration. Quantum dot element 202 can also be used in conjunction with an OLED display that displays multiple colors of light. For example, a quantum dot element 202 can include quantum dots that emit light at non-visible light. Such a quantum dot element 202 can be used in conjunction with an OLED display that emits multiple colors of visible light to enable the display to also be used for biometric imaging via non-visible light.

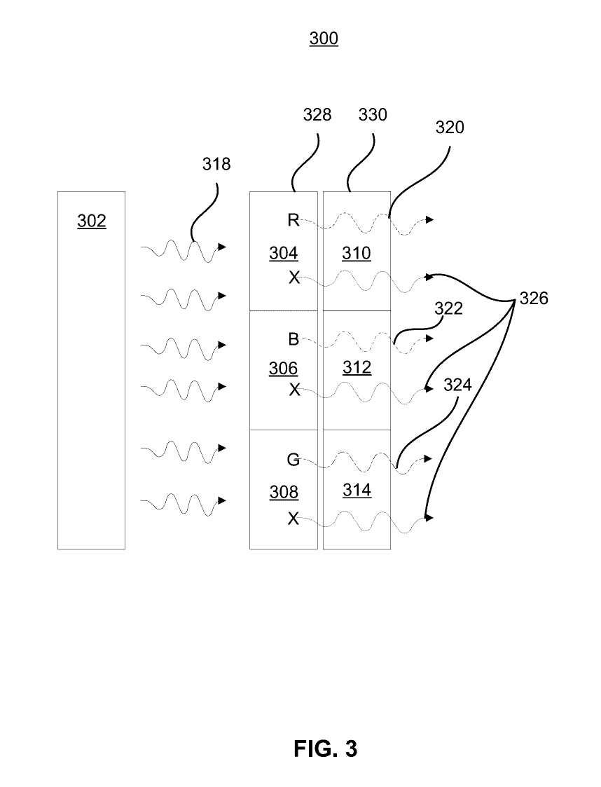

FIG. 3 illustrates a simplified diagram of a quantum dot element interacting with LCD cells according to certain embodiments. In FIG. 3, a system 300 is illustrated with a backlight 302, a quantum dot element 328 and an LCD pixel 330. Quantum dot element 328 can be similar to quantum dot element 202. LCD pixel 330 can be similar to LCD component 104. Backlight 302 can be similar to backlight 106. Illustrated is light 318 emitted at a first wavelength (e.g., blue).

Quantum dot element 328 is illustrated as including various sections 304, 306, and 308 each corresponding to a respective cell (310, 312, and 314) of LCD pixel 330. As illustrated, light 318 emitted by backlight 302 can impinge upon each section 304, 306, and 308. Each section can correspond to a color of light (for example, a primary color). Thus, each section can correspond to a subpixel. Section 304, for example, includes a quantum dot configured to emit red light 320 (denoted by the letter “R”). Similarly, section 306 can include quantum dot(s) emit blue light 322 (denoted by the letter “B”) and section 308 can include quantum dot(s) emit green light 324 (denoted by the letter “G”). Any of sections 304, 306, or 308 can include quantum dots configured to emit non-visible light 326 (denoted by the letter “X”). Although each of section 304, 306, and 308 are illustrated as including a non-visible light emitting quantum dot, any of the sections can emit non-visible light in any combination.

Furthermore, it should be understood that a section (such as section 306) may not include a quantum dot to emit a color of light. For example, light 318 can be blue light. Therefore, a quantum dot to emit blue light may not be needed.

As illustrated, LCD pixel 330 includes cells 310, 312, and 314 each respectively corresponding to section 304, 306, and 308. As disclosed herein, visible light colors 320, 322, and 324 can each be attenuated by a cell 310, 312, or 314. A pixel can comprise a plurality of cells. Thus, by attenuating distinct colors of visible light, a pixel can display any combination of the colors of attenuated light. However, non-visible light 326 may bass through cells 310, 312, and 314 regardless of the attenuating state of the cells. Therefore, in certain embodiments, each cell of an LCD panel can transmit non-visible light for imagining a biometric object regardless of a displayed image of the display. However, in certain embodiments, cell(s) can correspond to non-visible light for imaging a biometric object or for other purposes. A cover glass (not shown) can be included for light 320, 322, 324, and/or 326 to pass through.

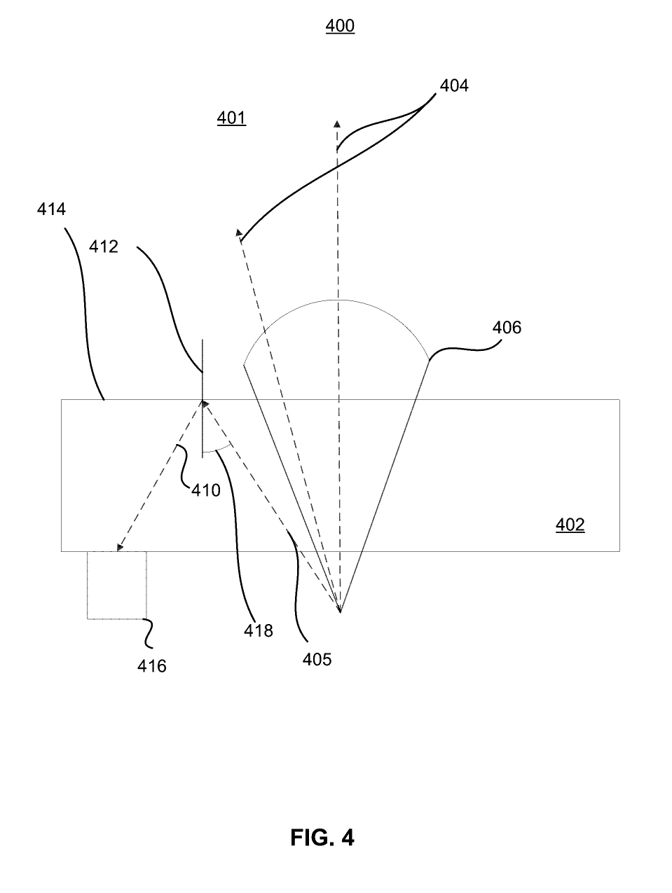

FIG. 4 illustrates features of light emitted through a cover glass according to certain embodiments. System 400 includes cover glass 402 that can be similar to cover glass 102. Light 404 can be emitted through cover glass 402 and can be similar to light 210. As illustrated, an angle 418 to a reference normal (i.e., perpendicular) to a surface 414 of cover glass 402 can be defined. If angle 418 is greater than a critical angle, then total internal reflectance 410 of light 405 can occur. Here, no biometric object is in contact with cover glass 402. Thus, the two relevant materials are open air 401 and cover glass 402. Surface 414 can indicate a barrier between cover glass 402 and open air 401. Open air 401 can have an index of refraction lower than cover glass 402. The critical angle can be defined by the equation

$${θ}_{C} = arcsin ( \frac{n 2}{n 1} ) ,$$

wherein θ_{C}=the critical angle, n2=an index of refraction of the second material (open air in this instance), and n1=an index of refraction of the first material (the cover glass 402 in this instance).

Light that is emitted at an angle greater than a critical angle can be totally internally reflected 410 and can be detected by a sensor 416. Sensor 416 can be similar to sensor 128. Thus, reflected light 410 can be detected by sensor 416 regardless if a biometric object is present to be imaged. Reflected light 410 can be totally internally reflected along cover glass 402 before reaching sensor 416. According to certain embodiments of the present disclosure, non-visible light, such as light 404, can be emitted through cover glass 402 at an angle 406 less than the critical angle, precluding total internal reflectance to occur and improving an ability of the system 400 to image a biometric object (by reducing noise that reduces a contrast of an image of a biometric object). Note that, although not illustrated, light 405 can be emitted through a medium collocated next to cover glass 402 that can be other than air. For example, a light emitter can emit through various mediums included in, for example, light guide(s), diffusion element(s), filter(s), or other mediums.

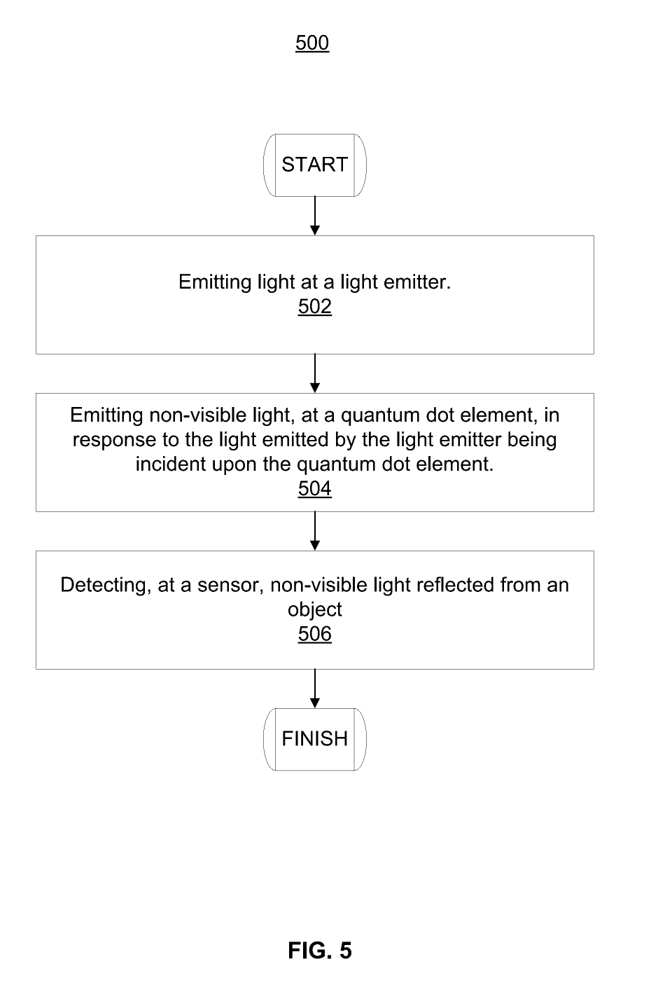

FIG. 5 illustrates a flowchart 500 for implementing techniques using certain embodiments. At 502, a light can be emitted at a light emitter. The light can be visible light or non-visible light. The light emitter can be light emitter 212, for example. At 504, non-visible light can be emitted by a quantum dot element in response to light emitted by the light emitter being incident upon the quantum dot element. The quantum dot element can be, for example, quantum dot element 202 and the light emitted by the quantum dot element can be light 204, 206, 208, 210 in response to light 214 emitted by light emitter 212, for example.

The non-visible light can be emitted through a cover glass (such as cover glass 102) at an angle less than a critical angle of the cover glass to preclude the non-visible light from totally internally reflecting within the cover glass when an object does not contact a surface of the cover glass (as described in detail regarding FIG. 4) or otherwise prior to being reflected by the object. At 506, non-visible light emitted by the quantum dot element can be detected at a sensor after reflecting from an object. The object can be biometric object 114, for example.

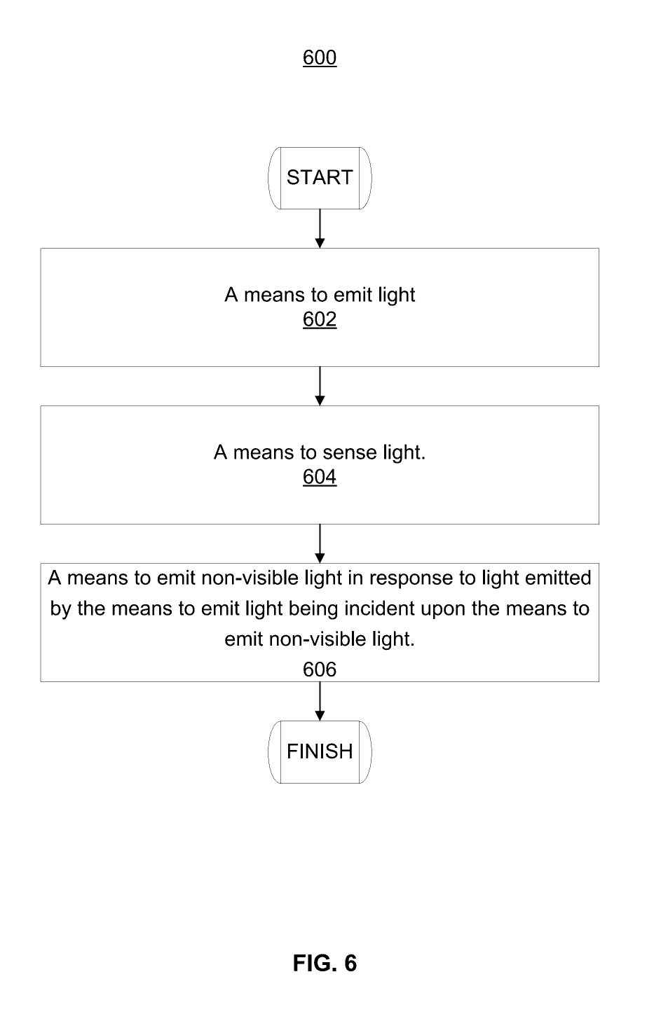

FIG. 6 illustrates a flowchart 600 for implementing a device using certain embodiments. At 602 is a means to emit light. The light can be visible light or non-visible light. The means to emit light can be light emitter 212, for example. At 604 is a means to sense light. For example, sensor 128 is an example means to sense light. At 606 is a means to emit non-visible light in response to light emitted by the means to emit light being incident upon the means to emit non-visible light. The means to emit non-visible light can, for example, be quantum dot element 202.

The means to emit non-visible light can configured to emit the non-visible light through a cover glass at an angle less than a critical angle of the cover glass (e.g., cover glass 102) to preclude the non-visible light from totally internally reflecting within the cover glass when an object does not contact a surface of the cover glass (as described in detail regarding FIG. 4) or otherwise prior to being reflected by the object. The means to sense light can be configured to detect non-visible light reflected from the object.

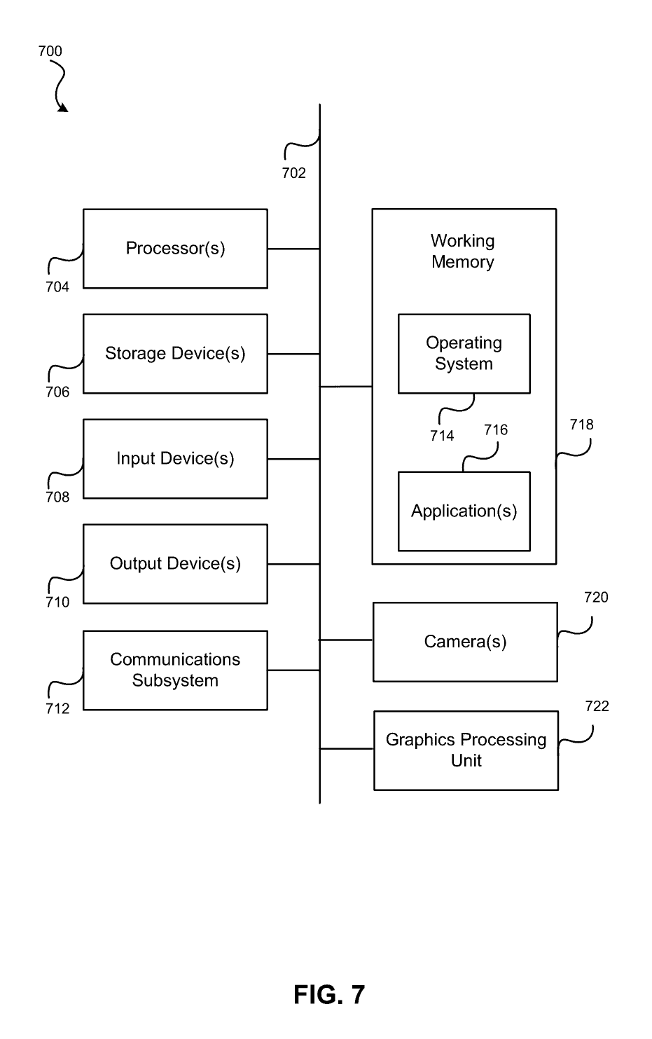

FIG. 7 illustrates an example of a computing system in which one or more embodiments may be implemented.

A computer system as illustrated in FIG. 7 may be incorporated as part of the above described computerized device. For example, computer system 700 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 7 provides a schematic illustration of one implementation of a computer system 700 that can perform the methods provided by various other implementations, as described herein, and/or can function as the host computer system, a remote kiosk/terminal, a point-of-sale device, a telephonic or navigation or multimedia interface in an automobile, a computing device, a set-top box, a table computer and/or a computer system. FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 702 (or may otherwise be in communication, as appropriate). The hardware elements may include one or more processors 704, including without limitation one or more general-purpose processors and/or one or more special-purpose processors (such as digital signal processing chips, graphics processing units 722, and/or the like); one or more input devices 708, which can include without limitation one or more cameras, sensors, a mouse, a keyboard, a microphone configured to detect ultrasound or other sounds, and/or the like; and one or more output devices 710, which can include without limitation a display unit such as the device used in implementations of the invention, a printer and/or the like. Additional cameras 720 may be employed for detection of user's extremities and gestures. In some implementations, input devices 708 may include one or more sensors such as infrared, depth, and/or ultrasound sensors. The graphics processing unit 722 may be used to carry out the method for real-time wiping and replacement of objects described above.

In some implementations of the implementations of the invention, various input devices 708 and output devices 710 may be embedded into interfaces such as display devices, tables, floors, walls, and window screens. Furthermore, input devices 708 and output devices 710 coupled to the processors may form multi-dimensional tracking systems.

The computer system 700 may further include (and/or be in communication with) one or more non-transitory storage devices 706, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 700 might also include a communications subsystem 712, which can include without limitation a modem, a network card (wireless or wired), an infrared communication device, a wireless communication device and/or chipset (such as a Bluetooth device, an 802.11 device, a WiFi device, a WiMax device, cellular communication facilities, etc.), and/or the like. The communications subsystem 712 may permit data to be exchanged with a network, other computer systems, and/or any other devices described herein. In many implementations, the computer system 700 will further comprise a non-transitory working memory 718, which can include a RAM or ROM device, as described above.

The computer system 700 also can comprise software elements, shown as being currently located within the working memory 718, including an operating system 714, device drivers, executable libraries, and/or other code, such as one or more application programs 716, which may comprise computer programs provided by various implementations, and/or may be designed to implement methods, and/or configure systems, provided by other implementations, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 706 described above. In some cases, the storage medium might be incorporated within a computer system, such as computer system 700. In other implementations, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which may be executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some implementations, one or more elements of the computer system 700 may be omitted or may be implemented separate from the illustrated system. For example, the processor 704 and/or other elements may be implemented separate from the input device 708. In one implementation, the processor may be configured to receive images from one or more cameras that are separately implemented. In some implementations, elements in addition to those illustrated in FIG. 7 may be included in the computer system 700.

Some implementations may employ a computer system (such as the computer system 700) to perform methods in accordance with the disclosure. For example, some or all of the procedures of the described methods may be performed by the computer system 700 in response to processor 704 executing one or more sequences of one or more instructions (which might be incorporated into the operating system 714 and/or other code, such as an application program 716) contained in the working memory 718. Such instructions may be read into the working memory 718 from another computer-readable medium, such as one or more of the storage device(s) 706. Merely by way of example, execution of the sequences of instructions contained in the working memory 718 might cause the processor(s) 704 to perform one or more procedures of the methods described herein.

The terms “machine-readable medium” and “computer-readable medium,” as used herein, refer to any medium that participates in providing data that causes a machine to operate in a specific fashion. In some implementations implemented using the computer system 700, various computer-readable media might be involved in providing instructions/code to processor(s) 704 for execution and/or might be used to store and/or carry such instructions/code (e.g., as signals). In many implementations, a computer-readable medium may be a physical and/or tangible storage medium. Such a medium may take many forms, including but not limited to, non-volatile media, volatile media, and transmission media. Non-volatile media include, for example, optical and/or magnetic disks, such as the storage device(s) 706. Volatile media include, without limitation, dynamic memory, such as the working memory 718. Transmission media include, without limitation, coaxial cables, copper wire and fiber optics, including the wires that comprise the bus 702, as well as the various components of the communications subsystem 712 (and/or the media by which the communications sub system 712 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 704 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various implementations of the invention.

The communications subsystem 712 (and/or components thereof) generally will receive the signals, and the bus 702 then might carry the signals (and/or the data, instructions, etc. carried by the signals) to the working memory 718, from which the processor(s) 704 retrieves and executes the instructions. The instructions received by the working memory 718 may optionally be stored on a non-transitory storage device 706 either before or after execution by the processor(s) 704.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

What is claimed is:

1. A biometric imaging system, comprising:
a light emitter;
a sensor;
a cover glass;
a quantum dot element disposed between the light emitter and the cover glass;
wherein the quantum dot element is configured to emit non-visible light in response to light emitted by the light emitter being incident upon the quantum dot element;
wherein the quantum dot element is configured to emit the non-visible light through the cover glass at an angle less than a critical angle of the cover glass to preclude the non-visible light from totally internally reflecting within the cover glass prior to reflecting from a biometric object; and
wherein the sensor is configured to detect non-visible light reflected from the object.

2. The biometric imaging system of claim 1, wherein the sensor is configured to detect non-visible light reflected from the object when the object contacts the surface of the cover glass.

3. The biometric imaging system of claim 1, wherein the non-visible light internally reflects within the cover glass after reflecting from the object and before being detected by the sensor.

4. The biometric imaging system of claim 1, further comprising a Liquid Crystal Display (LCD) pixel disposed between the quantum dot element and the cover glass, wherein the non-visible light passes through the LCD pixel.

5. The biometric imaging system of claim 1, wherein the quantum dot element is further configured to emit visible light in response to the light emitted by the light emitter incident upon the quantum dot element.

6. The biometric imaging system of claim 1, wherein the quantum dot element is further configured to emit the visible light at two or more different wavelengths, the two or more different wavelengths corresponding to visible colors.

7. The biometric imaging system of claim 6, wherein the two or more different wavelengths include wavelengths corresponding to red, blue, and green colors of light.

8. The biometric imaging system of claim 7, wherein the quantum dot element is configure to emit each of the two or more different wavelengths through a respective cell of an LCD.

9. The biometric imaging system of claim 7, wherein the quantum dot element is further configure to emit the non-visible light through a cell of the LCD.

10. The biometric imaging system of claim 1, wherein the sensor comprises an imaging sensor configured to capture an image of the object using the non-visible light.

11. The biometric imaging system of claim 1, wherein the non-visible light comprises infrared light.

12. A method of imaging, comprising:
emitting light, at a light emitter;
emitting non-visible light, at a quantum dot element, in response to the light emitted by the light emitter being incident upon the quantum dot element;
wherein the non-visible light is emitted through the cover glass at an angle less than a critical angle of the cover glass to preclude the non-visible light from totally internally reflecting within the cover glass prior to reflecting from a biometric object; and
detecting, at a sensor, non-visible light reflected from the object.

13. The method of imaging of claim 12, wherein the non-visible light internally reflects within the cover glass after reflecting from the object and before being detected by the sensor.

14. The method of imaging of claim 12, further comprising emitting visible light, at the quantum dot element, in response to the light emitted by the light emitter being incident upon the quantum dot element.

15. The method of imaging of claim 12, further comprising emitting, at the quantum dot element, two or more different wavelengths of light corresponding to visible colors.

16. The method of imaging of claim 15, wherein the two or more different wavelengths correspond to visible colors including red, blue, and green colors of light.

17. The method of claim 15, further comprising emitting the two or more different wavelengths, at the quantum dot element, through a respective cell of a Liquid Crystal Display (LCD).

18. The method of imaging of claim 16, further comprising emitting each of the two or more different wavelengths through a respective cell of the LCD pixel.

19. The method of imaging of claim 12, further comprising capturing an image of the object using the non-visible light at the sensor.

20. A biometric imaging system, comprising:
a means to emit light;
a means to sense light;
a means to emit non-visible light in response to light emitted by the means to emit light being incident upon the means to emit non-visible light;
wherein the means to emit non-visible light is configured to emit the non-visible light through the cover glass at an angle less than a critical angle of the cover glass to preclude the non-visible light from totally internally reflecting within the cover glass prior to reflecting from a biometric object; and
wherein the means to sense light is configured to detect non-visible light reflected from the object.
